(19) United States
(12) Patent Application Publication
(10) Pub. No.: US 2019/0317472 A1
(43) Pub. Date: Oct. 17, 2019

(54) CONTROLLER AND CONTROL METHOD

(71) Applicant: Fanuc Corporation, Yamanashi (JP)

(72) Inventors: Chao Zhi, Minamitsuru-gun (JP); Wenjie Chen, Minamitsuru-gun (JP); Kaimeng Wang, Minamitsuru-gun (JP); Kazuomi Maeda, Minamitsuru-gun (JP)

(73) Assignee: Fanuc Corporation, Yamanashi (JP)

(21) Appl. No.: 16/382,962

(22) Filed: Apr. 12, 2019

(30) Foreign Application Priority Data
Apr. 17, 2018 (JP) 2018-079450
Jan. 31, 2019 (JP) 2019-015507

(51) Int. Cl. G05B 19/402; G06N 20/00

(52) U.S. Cl. CPC G05B 19/402; G05B 2219/42063; G06N 20/00

(57) ABSTRACT

A controller that performs, for one or more axes of a machine, position control by taking friction into consideration includes a data acquisition unit acquiring at least a position command and a position feedback and a compensation torque estimation unit estimating coefficients of a friction model used when the position control is performed, on the basis of a position deviation which is a difference between the position command and the position feedback.

### RELATED APPLICATION

The present application claims priority to Japanese Application Number 2018-079450 filed Apr. 17, 2018, and Japanese Application Number 2019-015507 filed Jan. 31, 2019, the disclosure of which is hereby incorporated by reference herein in its entirety.

### BACKGROUND OF THE INVENTION

### 1. Filed of the Invention

The present invention relates to a controller and a control method and, in particular, to a controller and a control method that are capable of identifying coefficients of a friction model.

### 2. Description of the Related Art

In control of industrial machines (hereinafter simply referred to as machines), including machine tools, injection molders, laser beam machines, electric discharge machines, industrial robots and the like, precise control performance can be achieved by compensating for frictional forces acting on driving mechanisms.

FIG. 11 illustrates an example of a driving mechanism of a machine tool. A servo motor rotates and drives a ball screw supported by bearings to move a stage. During this operation, frictional forces act between each the bearing and the ball screw and between the ball screw and the stage, for example. In other words, the behavior of the stage is affected by the frictional forces.

FIG. 12 is a graph of a typical relationship between frictional force and behavior of the driving mechanism. During the transition from a rest state (speed=0) to a motion state or from a motion state to a rest state, changes in frictional force is nonlinear. This is called the Stribeck effect. Due to the Stribeck effect, the time required for positioning increases or a trajectory error (quadrant projection) occurs during reversal in the machine.

The Lugre model is known as a friction model that is effective in considering compensation for such nonlinear friction. By using the Lugre model, a compensation value (compensation torque) for reducing a nonlinear frictional effect can be obtained. As illustrated in FIG. 13, by adding the compensation value to an electric current command, a nonlinear frictional force is compensated for and an object to be controlled can be precisely controlled. This compensation processing can be performed in well-known feedback control. A controller for a machine determines an electric current command on the basis of a deviation between a position command and a position feedback and a deviation between a speed command and a speed feedback. The controller then adds a compensation torque which can be obtained using the Lugre model to the electric current command.

The Lugre model is represented in Formula 1. Here, F is the compensation torque which is an output of the Lugre model; v and z are variable relating to speed and position; and Fc, Fs, v0, σ0, σ1, and σ2 are coefficients specific to a driving mechanism.

$$F = {σ}_{0} z + {σ}_{1} \frac{dz}{dt} + {σ}_{2} v \\ \frac{dz}{dt} = v - \frac{\vert v \vert}{g ( v )} z \\ {σ}_{0} g ( v ) = {F}_{c} + ( {F}_{s} - {F}_{c} ) {e}^{- {( v / {v}_{0} )}^{2}} \qquad [ Formula 1 ]$$

As a related art, Japanese Patent Laid-Open No. 2004-234327 discloses that compensation data can be acquired from a friction model.

However, coefficients have been needed to be individually identified for each object to be controlled because coefficients of friction models, including the Lugre model, differ among machines, use environments and the like. Further, because many coefficients are to be identified, the coefficient identification operation has taken much effort. Therefore, there is a need for means capable of identifying coefficients of a friction model without effort.

### SUMMARY OF THE INVENTION

Therefore, there is a demand for a controller and a control method that are capable of identifying coefficients of a friction model.

One aspect of the present invention is a controller performing, for one or more axes of a machine, position control that takes friction into consideration, the controller including: a data acquisition unit acquiring at least a position command and a position feedback; and a compensation torque estimation unit estimating coefficients of a friction model used when the position control is performed, on the basis of a position deviation that is a difference between the position command and the position feedback.

Another aspect of the present invention is a control method for performing, for one or more axes of a machine, position control that takes friction into consideration, the control method including: a data acquisition step of acquiring at least a position command and a position feedback; and a compensation torque estimation step of estimating coefficients of a friction model used when the position control is performed, on the basis of a position deviation that is a difference between the position command and the position feedback.

According to the present invention, a controller and a control method that are capable of identifying coefficients of a friction model can be provided.

### BRIEF DESCRIPTION OF THE DRAWINGS

The object and features described above and other objects and features of the present invention will be apparent from the following description of example embodiments with reference to the accompanying drawings, in which:

FIG. 1 is a schematic hardware configuration diagram of a controller 1 according to a first embodiment;

FIG. 2 is a schematic functional block diagram of the controller 1 according to the first embodiment;

FIG. 3 is a schematic hardware configuration diagram of a controller 1 according to second and third embodiments;

FIG. 4 is a schematic functional block diagram of the controller 1 according to the second embodiment;

FIG. 5 is a functional block diagram of a learning unit 83 in the second embodiment;

FIG. 6 is a flowchart illustrating one mode of reinforcement learning;

FIG. 7A is a diagram illustrating a neuron;

FIG. 7B is a diagram illustrating a neural network;

FIG. 8 is a schematic functional block diagram of the controller 1 and a machine learning device 100 according to the third embodiment;

FIG. 9 is a schematic functional block diagram illustrating one mode of a system incorporating a controller 1;

FIG. 10 is a schematic functional block diagram illustrating another mode of a system incorporating a machine learning device 120 (or 100);

FIG. 11 is a diagram illustrating one example of a driving mechanism of a machine tool;

FIG. 12 is a graph illustrating a relationship between frictional force and behavior of the driving mechanism;

FIG. 13 is a diagram illustrating one example of a method for compensating for a nonlinear frictional force by using a friction model;

FIG. 14 is a diagram illustrating another example of a method for compensating for a nonlinear frictional force by using a friction model; and

FIG. 15 is a diagram illustrating another example of a method for compensating for a nonlinear frictional force by using a friction model.

### DETAILED DESCRIPTION OF THE PREFERRED EMBODIMENTS

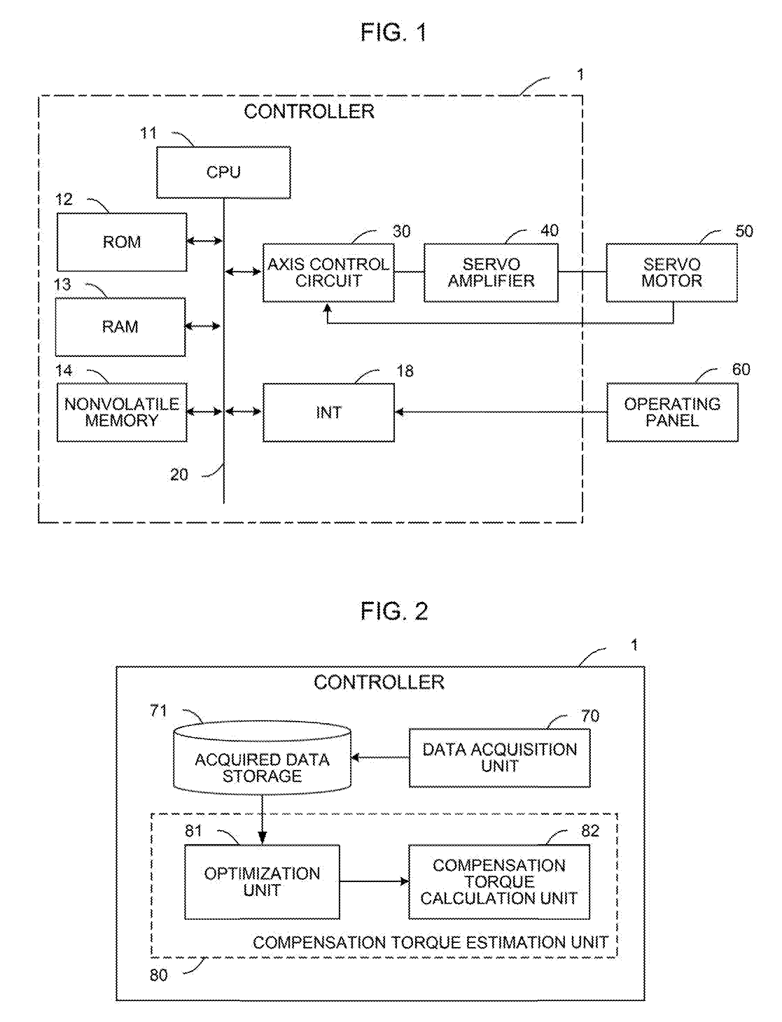

FIG. 1 is a schematic hardware configuration diagram illustrating a controller 1 according to a first embodiment of the present invention and a related part of an industrial machine controlled by the controller 1. The controller 1 is a controller that controls a machine, such as a machine tool. The controller 1 includes a CPU 11, a ROM 12, a RAM 13, a nonvolatile memory 14, an interface 18, a bus 20, an axis control circuit 30, and a servo amplifier 40. A servo motor 50 and an operating panel 60 are connected to the controller 1.

The CPU 11 is a processor that generally controls the controller 1. The CPU 11 reads out a system program stored on the ROM 12 through the bus 20 and controls the whole controller 1 in accordance with the system program.

The ROM 12 stores, in advance, system programs (including a communication program for controlling communication with a machine learning device 100, which will be described later) for performing various kinds of control and the like of the machine.

The RAM 13 temporarily stores temporary computation data, display data and data such as data input by an operator through the operating panel 60, which will be described later.

The nonvolatile memory 14 is backed up, for example, by a battery, not depicted, and maintains a stored state even when the controller 1 is powered off. The nonvolatile memory 14 stores, among others, data input from the operating panel 60, programs and data for controlling the machine that are input through an interface, not depicted. The programs and data stored on the nonvolatile memory 14 may be loaded into the RAM 13 when the programs and the data are executed and used.

The axis control circuit 30 controls operation axes of the machine. The axis control circuit 30 receives a commanded axis move amount output from the CPU 11 and outputs an axis current command to the servo amplifier 40. At this point in time, the axis control circuit 30 performs feedback control, which will be described later and, in addition, performs compensation of a nonlinear frictional force using a compensation torque output by the CPU 11 on the basis of the Lugre model or the like. Alternatively, the axis control circuit 30 may compensate a nonlinear frictional force using a compensation torque calculated by the axis control circuit 30 on the basis of the Lugre model or the like. In general, compensation performed within the axis control circuit 30 is faster than compensation performed in the CPU 11.

The servo amplifier 40 receives an axis current command output from the axis control circuit 30 and drives the servo motor 50.

The servo motor 50 is driven by the servo amplifier 40 to move an axis of the machine. The servo motor 50 typically incorporates a position/speed detector. Alternatively, a position detector may be provided on the machine side instead of being incorporated in the servo motor 50. The position/speed detector outputs a position/speed feedback signal, which is fed back to the axis control circuit 30, thereby feedback control of a position/speed is performed.

It should be noted that while only one axis control circuit 30, one servo amplifier 40 and one servo motor 50 are shown in FIG. 1, as many of each of these components as the number of axes of the machine to be controlled are provided in practice. For example, when a machine including 6 axes are controlled, a total of six sets of an axis control circuit 30, a servo amplifier 40 and a servo motor 50 corresponding to each axis are provided.

The operating panel 60 is a data input device equipped with hardware keys and the like. Among such operating panels, is a manual data input device, called a teaching operation panel, equipped with a display, hardware keys and the like. The teaching operation panel displays information received from the CPU 11 through the interface 18 on the display. The operating panel 60 provides pulses, commands, data and the like input from hardware keys and the like to the CPU 11 through the interface 18.

FIG. 2 is a schematic functional block diagram of the controller 1 according to the first embodiment. The functional blocks illustrated in FIG. 2 are implemented by the CPU 11 of the controller 1 illustrated in FIG. 1 executing a system program and controlling operations of components of the controller 1.

The controller 1 according to the present embodiment includes a data acquisition unit 70 and a compensation torque estimation unit 80. The compensation torque estimation unit 80 includes an optimization unit 81 and a compensation torque calculation unit 82. Further, an acquired data storage 71 for storing data acquired by the data acquisition unit 70 is provided on the nonvolatile memory 14.

The data acquisition unit 70 is functional means for acquiring various kinds of data from the CPU 11, the servo motor 50, the machine and the like. The data acquisition unit 70 acquires a position command, a position feedback, a speed command and a speed feedback, for example, and stores them in the acquired data storage 71.

The compensation torque estimation unit 80 is functional means for estimating optimal coefficients (Fc, Fs, v0, σ0, σ1, σ2 in the case of the Lugre model) in a friction model (typically the Lugre model) based on the data stored in the acquired data storage 71. In the present embodiment, the optimization unit 81 estimates coefficients of a friction model by solving an optimization problem that minimizes a deviation between a position command and a position feedback, for example. Typically, a combination of coefficients that minimizes a deviation between a position command and a position feedback can be estimated using a method such as a grid search, which exhaustively searches for a combination of coefficients, a random search, which randomly tries combinations of coefficients, or Bayesian optimization, which searches for an optimal combination of coefficients on the basis of a probability distribution and an acquisition function. That is, the optimization unit 81 repeats a cycle of causing the machine to operate while changing one combination of coefficients to another and evaluating a deviation between a position command and a position feedback, thereby finding a combination of coefficients that minimizes the deviation.

The compensation torque calculation unit 82 uses a result of the estimation (an optimal combination of coefficients of the friction model) by the optimization unit 81 to calculate and output a compensation torque based on the friction model. The controller 1 adds the compensation torque output from the compensation torque calculation unit 82 to an electric current command.

According to the present embodiment, optimal coefficients suitable for various machines and use environments can be easily obtained because the optimization unit 81 identifies coefficients of a friction model by solving an optimization problem.

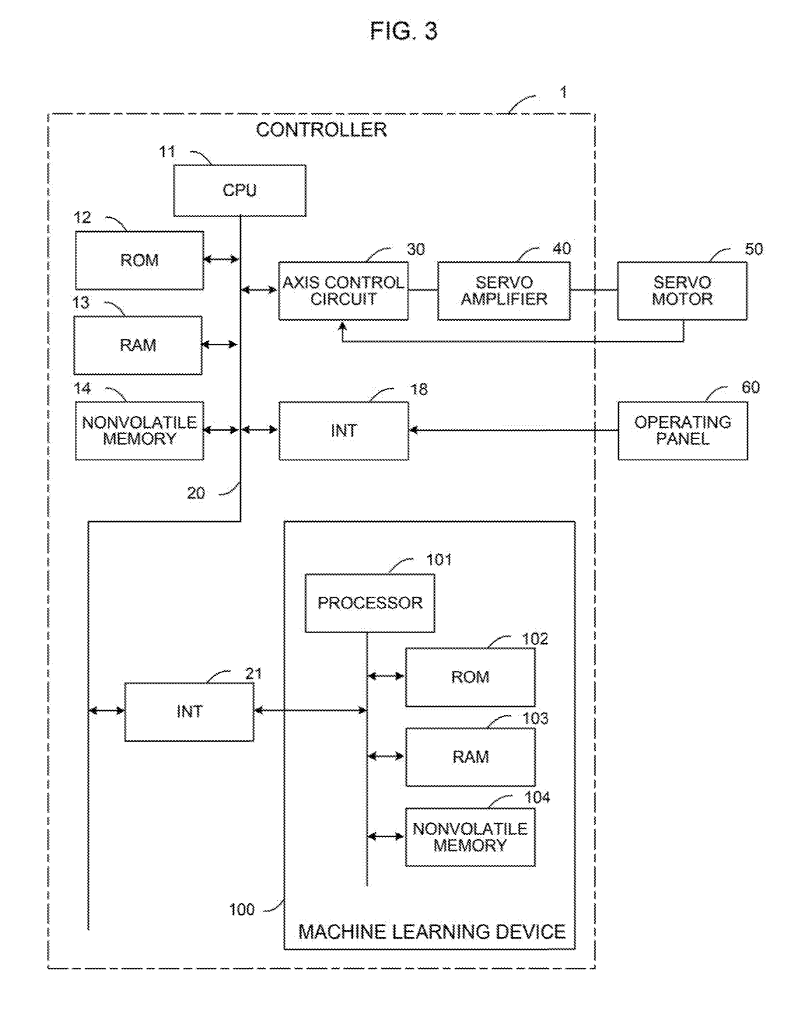

FIG. 3 is a schematic hardware block diagram of a controller 1 including a machine learning device 100, according to second and third embodiment. The controller 1 according to the present embodiments has a configuration similar to the configuration of the first embodiment except that a configuration relating to the machine learning device 100 is provided. System programs, including a communication program for controlling communication with the machine learning device 100, are written in advance on a ROM 12 provided in the controller 1 according to the present embodiments.

An interface 21 is an interface used for interconnecting the controller 1 and the machine learning device 100. The machine learning device 100 includes a processor 101, a ROM 102, a RAM 103 and a nonvolatile memory 104.

The processor 101 controls the whole machine learning device 100. The ROM 102 stores system programs and the like. The RAM 103 provides temporary storage in each kind of processing relating to machine learning. The nonvolatile memory 104 stores a learning model and the like.

The machine learning device 100 observes, through the interface 21, various kinds of information (such as a position command, a speed command, and position feedbacks) that can be obtained by the controller 1. The machine learning device 100 learns and estimates, by machine learning, coefficients of a friction model (typically the Lugre model) for precisely controlling a servo motor 50 and outputs a compensation torque to the controller 1 through the interface 21.

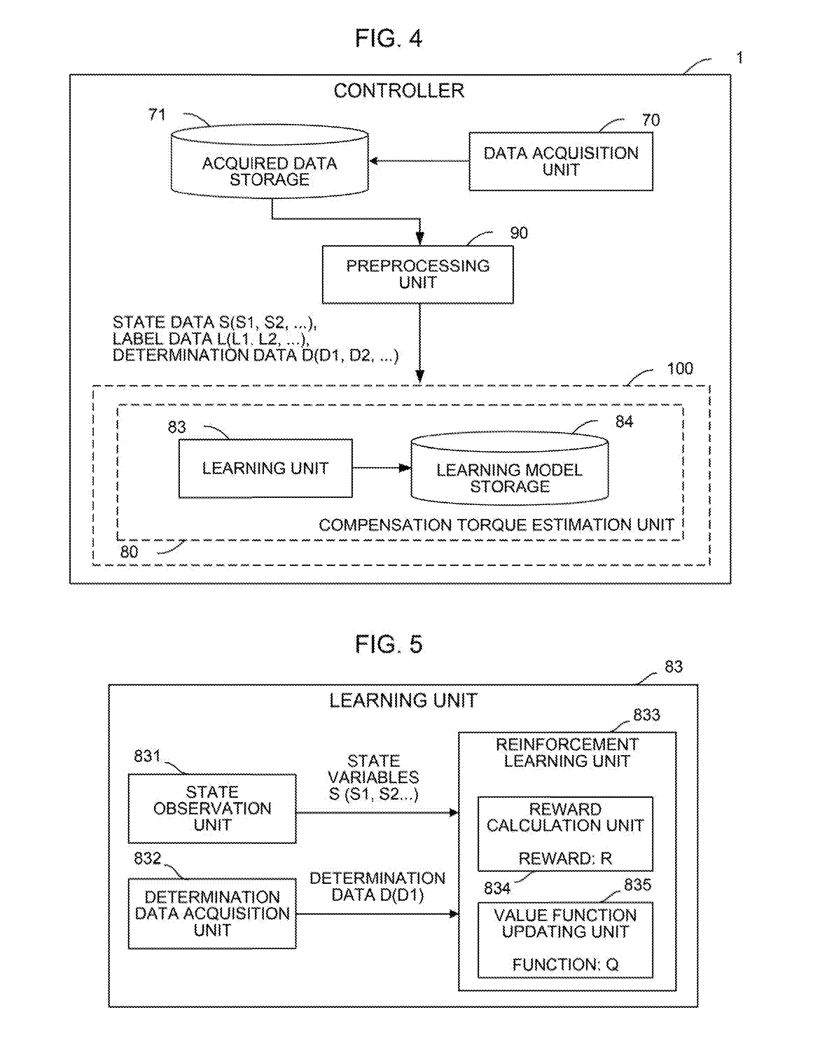

FIG. 4 is a schematic functional block diagram of the controller 1 and the machine learning device 100 according to the second embodiment. The controller 1 illustrated in FIG. 4 has a configuration required for the machine learning device 100 to perform learning (a learning mode). The functional blocks illustrated in FIG. 4 are implemented by the CPU 11 of the controller 1 and a processor 101 of the machine learning device 100 illustrated in FIG. 3 executing their respective system programs and controlling operations of components of the controller 1 and the machine learning device 100.

The controller 1 according to the present embodiment includes a data acquisition unit 70, and a compensation torque estimation unit 80, which is configured on the machine learning device 100. The compensation torque estimation unit 80 includes a learning unit 83. Further, an acquired data storage 71 for storing data acquired by the data acquisition unit 70 is provided on a nonvolatile memory 14 and a learning model storage 84 for storing a learning model built through machine learning by the learning unit 83 is provided on a nonvolatile memory 104 of the machine learning device 100.

The data acquisition unit 70 in the present embodiment operates in a manner similar to that in the first embodiment. The data acquisition unit 70 acquires a position command, a position feedback, a speed command and a speed feedback, for example, and stores them in the acquired data storage 71. Further, the data acquisition unit 70 acquires a set of coefficients (Fc, Fs, v0, σ0, σ1, σ2) of the Lugre model currently being used by the controller 1 for compensating nonlinear friction and stores the set in the acquired data storage 71.

Based on the data acquired by the data acquisition unit 70, a preprocessing unit 90 creates learning data to be used in machine learning by the machine learning device 100. The preprocessing unit 90 converts (by digitizing, sampling or otherwise processing) each piece of data to a uniform format that is handled in the machine learning device 100, thereby creating learning data. When the machine learning device 100 performs unsupervised learning, the preprocessing unit 90 creates state data S in a predetermined format used in the learning as learning data; when the machine learning device 100 performs supervised learning, the preprocessing unit 90 creates a set of state data S and label data L in a predetermined format used in the learning as learning data; and when the machine learning device 100 performs reinforcement learning, the preprocessing unit 90 creates a set of state data S and determination data D in a predetermined format used in the learning as learning data.

The learning unit 83 performs machine learning using learning data created by the preprocessing unit 90. The learning unit 83 generates a learning model by using a well-known machine learning method, such as unsupervised learning, supervised learning, or reinforcement learning and stores the generated learning model in the learning model storage 84. The unsupervised learning methods performed by the learning unit 83 may be, for example, an autoencoder method or a k-means method; the supervised learning methods may be, for example, a multilayer perceptron method, a recurrent neural network method, a Long Short-Term Memory method, or a convolutional neural network method; and the reinforcement learning method may be, for example, Q-learning.

FIG. 5 illustrates an internal functional configuration of the learning unit 83 that performs reinforcement learning, as an example of learning methods. Reinforcement learning is a method in which a cycle of observing a current state (i.e. an input) of an environment in which an object to be learned exists, performing a given action (i.e. an output) in the current state, and giving some reward for the action is repeated in a try-and-error manner and a policy (setting of coefficients of the Lugre model in the present embodiment) that maximizes the sum of rewards is learned as the optimal solution.

The learning unit 83 includes a state observation unit 831, a determination data acquisition unit 832, and a reinforcement learning unit 833. The functional blocks illustrated in FIG. 5 are implemented by the CPU 11 of the controller 1 and the processor 101 of the machine learning device 100 illustrated in FIG. 3 executing their respective system programs and controlling operations of components of the controller 1 and the machine learning device 100.

The state observation unit 831 observes state variables S which represent the current state of the environment. The state variables S include, for example, current coefficients S1 of the Lugre model, a current position command S2, a current speed command S3 and a position feedback S4 in the previous cycle.

As the coefficients S1 of the Lugre model, the state observation unit 831 acquires a set of coefficients (Fc, Fs, v0, σ0, σ1, σ2) of the Lugre model that are currently being used by the controller 1 for compensating nonlinear friction.

As the current position command S2 and the current speed command S3, the state observation unit 831 acquires a position command and a speed command currently being output from the controller 1.

As the position feedback S4, the state observation unit 831 acquires a position feedback acquired by the controller 1 in the previous cycle (which was used in feedback control for generating the current position command and the current speed command).

The determination data acquisition unit 832 acquires determination data D which is an indicator of a result of control of the machine performed under state variables S. The determination data D includes a position feedback D1.

As the position feedback D1, the determination data acquisition unit 832 acquires a position feedback which can be obtained as a result of controlling the machine on the basis of coefficients S1 of the Lugre model, a position command S2 and a speed command S3.

The reinforcement learning unit 833 learns correlation of coefficients S1 of the Lugre model with a position command S2, a speed command S3 and a position feedback S4 using state variables S and determination data D. That is, the reinforcement learning unit 833 generates a model structure that represents correlation among components S1, S2, S3 and S4 of state variables S. The reinforcement learning unit 833 includes a reward calculation unit 834 and a value function updating unit 835.

The reward calculation unit 834 calculates a reward R relating to a result of position control (which corresponds to determination data D to be used in a learning cycle that follows the cycle in which the state variables S were acquired) when coefficients of the Lugre model are set on the basis of the state variables S.

The value function updating unit 835 updates a function Q representing a value of a coefficient of the Lugre model using a reward R. Through repetition of updating of the function Q by the value function updating unit 835, the reinforcement learning unit 833 learns correlation of coefficients S1 of the Lugre model with a position command S2, a speed command S3 and a position feedback S4.

An example of an algorithm for reinforcement learning performed by the reinforcement learning unit 833 will be described. The algorithm in this example is known as Q-learning and is a method of learning a Q-function (s, a) representing an action value when an action “a” is selected in a state “s”, where the state “s” and the action “a” are independent variables, the state “s” is the state of an actor and the action “a” is an action that can be selected by the actor in the state “s”. The optimal solution is to select an action “a” that yields the highest value of the value function Q in the state “s”. Q-learning is started from a state in which correlation between a state “s” and an action “a” is unknown and try and error to select various actions “a” in an arbitrary state “s” is repeated, thereby repeatedly updating the value function Q so as to approach the optimal solution. Here, the value function Q can be made closer to the optimal solution in a relatively short time by making a configuration in such a manner that when the environment (namely the state “s”) changes as a result of selection of an action “a” in the state “s”, a reward “r” (i.e. weighing of the action “a”) responsive to the change can be received and inducing the learning so as to select an action “a” that yields a higher reward “r”.

In general, a formula for updating the value function Q can be expressed as Formula 2 given below. In Formula 2, sₜ and aₜ are a state and an action, respectively, at time t, and the state changes to sₜ₊₁ as a result of the action aₜ. rₜ₊₁ is a reward that can be received when the state changes from sₜ to sₜ₊₁. The term of maxQ means Q when an action “a” that yields (is considered at time t to yield) the maximum value Q is performed at time t+1. α and γ are a learning rate and a discount factor, respectively, and are arbitrarily set in the ranges of 0≤α≤1 and 0<γ≤1.

$$Q ( {S}_{i} , {a}_{t} ) ← Q ( {S}_{i} , {a}_{t} ) + α ( {r}_{i + 1} + γ {max}_{a} Q ( {S}_{i + 1} , a ) - Q ( {S}_{i} , {a}_{i} ) ) \qquad [ Formula 2 ]$$

When the reinforcement learning unit 833 performs Q-learning, state variables S observed by the state observation unit 831 and determination data D acquired by the determination data acquisition unit 832 correspond to the state “s” in the update formula, the action of determining coefficients S1 of the Lugre model for the current state, that is, for a position command S2, a speed command S3 and a position feedback S4 corresponds to the action “a” in the update formula, and reward R calculated by the reward calculation unit 834 corresponds to the reward “r” in the update formula. Accordingly, the value function updating unit 835 repeatedly updates the function Q representing values of coefficients of the Lugre model for the current state through the Q-learning using reward R.

When machine control based on determined coefficients S1 of the Lugre model is performed and a result of the position control is determined to be “acceptable”, for example, the reward calculation unit 834 can provide a positive value of reward R. On the other hand, when the result is determined to be “unacceptable”, the reward calculation unit 834 can provide a negative value of reward R. The absolute values of positive and negative rewards R may be equal or unequal to each other.

A result of position control is “acceptable” when a difference between a position feedback D1 and a position command S2, for example, is within a predetermined threshold. A result of position control is “unacceptable” when a difference between a position feedback D1 and a position command S2, for example, exceeds the predetermined threshold. In other words, when position control is achieved with a degree of accuracy higher than or equal to a predetermined criterion in response to the position command S2, the result is “acceptable”; otherwise, the result is “unacceptable”.

Instead of the binary determination between “acceptable” and “unacceptable”, multiple grades may be set for results of position control. For example, the reward calculation unit 834 may set multi-grade rewards such that the smaller the difference between a position feedback D1 and a position command S2, the greater the reward.

The value function updating unit 835 may have an action value table in which states variables S, determination data D and rewards R are associated with action values (for example numerical values) expressed by the function Q and organized. In this case, the action of updating the function Q by the value function updating unit 835 is synonymous with the action of updating the action value table by the value function updating unit 835. Because correlation of coefficients S1 of the Lugre model with a position command S2, a speed command S3 and a position feedback S4 is unknown at the beginning of Q-learning, various state variables S, determination data D and rewards D are provided in association with arbitrarily determined numerical values of the action value (Q-function) in the action value table. When determination data D becomes known, the reward calculation unit 834 can immediately calculate a reward R that corresponds to the determination data D and writes the calculated value R in the action value table.

As the Q-learning proceeds using rewards R that are responsive to results of position control, the learning is induced to select an action for which a higher reward R can be received and a numerical value of the action value (function Q) for an action performed in the current state is rewritten in accordance with the state (i.e. state variables S and determination data D) of the environment that changes as a result of the selected action being performed in the current state, thereby updating the action value table. By repeating such update, numerical values of the action value (Q-function) displayed on the action value table are rewritten such that more appropriate actions yield greater values. In this way, correlation of the current state of the environment, i.e. a position command S2, a speed command S3 and a position feedback S4 with an action in response to them, i.e. set coefficients S1 of the Lugre model, which has been unknown, gradually becomes apparent. In other words, correlation of coefficients S1 of the Lugre model with the position command S2, the speed command S3 and the position feedback S4 gradually approaches the optimal solution as the action value table is updated.

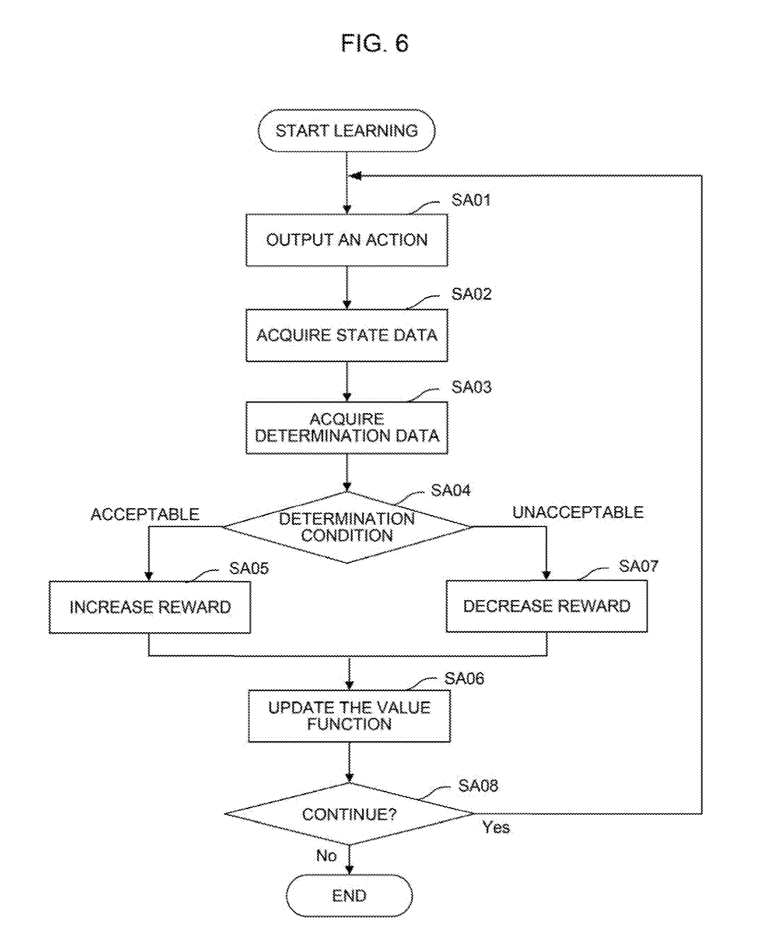

A flow of Q-learning (i.e. one mode of machine learning) performed by the reinforcement learning unit 833 will be described in further detail with reference to FIG. 6.

Step SA01: With reference to the action value table at the present point in time, the value function updating unit 835 randomly selects coefficients S1 of the Lugre model as an action to be performed in the current state indicated by state variables S observed by the state observation unit 831.

Step SA02: The value function updating unit 835 takes state variables S in the current state being observed by the state observation unit 831.

Step SA03: The value function updating unit 835 takes determination data D in the current state being acquired by the determination data acquisition unit 832.

Step SA04: Based on the determination data D, the value function updating unit 835 determines whether the coefficients S1 of the Lugre model are appropriate or not. When the coefficient S is appropriate, the flow proceeds to step SA05. When the coefficient S is not appropriate, the flow proceeds to step SA07.

Step SA05: The value function updating unit 835 applies a positive reward R calculated by the reward calculation unit 834 to the function Q update formula.

Step SA06: The value function updating unit 835 updates the action value table with the state variable S and the determination data D in the current state and the value of reward R and the numerical value of the action value (updated function Q).

Step SA07: The value function updating unit 835 applies a negative reward R calculated by the reward calculation unit 834 to the function Q update formula.

The reinforcement learning unit 833 repeats step SA01 to SA07 to repeatedly updates the action value table and proceeds with the learning. It should be noted that the process from step SA04 to step SA07 for calculating the reward R and updating the value function is performed for each piece of data included in the determination data D.

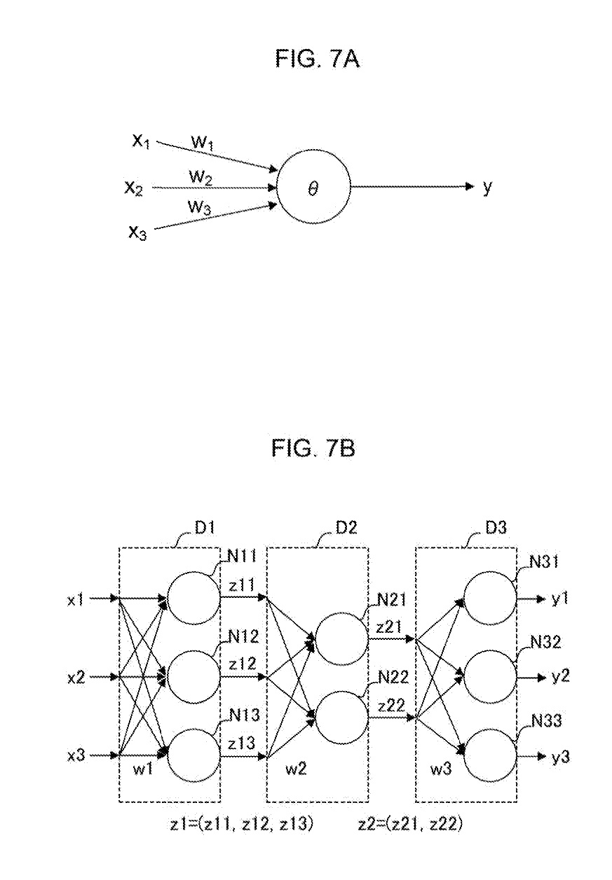

When reinforcement learning is performed, a neural network, for example, can be used instead of Q-learning. FIG. 7A schematically illustrates a neuron model. FIG. 7B schematically illustrates a three-layer neural network model configured by combining neurons including the neuron illustrated in FIG. 7A. A neural network can be configured with a processor and a storage device and the like that mimic a model of neurons, for example.

The neuron illustrated in FIG. 7A outputs a result y in response to a plurality of inputs x (here, inputs X₁ to x₃ are shown as an example). Each of the inputs x₁ to x₃ is multiplied by a weight w (w1 to w3) that corresponds to the input x. Thus, the neuron provides the output y that is expressed by Formula 3 given below. Note that, in Formula 3, all of the inputs x, output y and weights w are vectors. Further, θ is a bias and fₖ is an activating function.

y=fₖ(Σᵢ₌₁ⁿxᵢwᵢ−θ) [Formula 3]

The three-layer neural network illustrated in FIG. 7B takes a plurality of inputs x (input x1 to input x3 are shown here as an example) on the left-hand side and outputs results y (results y1 to y3 are shown here as an example) on the right-hand side. In the illustrated example, each of the inputs x1, x2 and x3 is multiplied by a corresponding weight (collectively denoted by W1) and all of the individual inputs x1, x2 and x3 are input into three neurons N11, N12 and N13.

In FIG. 7B, outputs from the neurons N11 to N13 are collectively denoted by z1. z1 can be considered to be feature vectors of feature quantities extracted from input vectors. In the illustrated example, each of the feature vectors z1 is multiplied by a corresponding weight (collectively denoted by W2) and all of the individual feature vectors z1 are input into two neurons N21 and N22. The feature vectors z1 represent features between weights W1 and W2.

In FIG. 7B, outputs from the neurons N21 and N22 are collectively denoted by z2. z2 can be considered to be feature vectors of feature quantities extracted from the feature vectors z1. In the illustrated example, each of the feature vectors z2 is multiplied by a corresponding weight (collectively denoted by W3) and all of the individual feature vectors z2 are input into three neurons N31, N32 and N33. The feature vectors z2 represent features between the weights W2 and W3. Finally, the neurons N31 to N33 output results y1 to y3, respectively.

It should be noted that the so-called deep learning, which uses a neural network that has three or more layers, can also be used.

By repeating the learning cycle as described above, the reinforcement learning unit 833 becomes able to automatically identify features that imply correlation of coefficients S1 of the Lugre model with a position command S2, a speed command S3 and a position feedback S4. At the beginning of a learning algorithm, correlation of the coefficients S1 of the Lugre model with the position command S2, the speed command S3 and the position feedback S4 is practically unknown. However, as the learning proceeds, the reinforcement learning unit 833 gradually becomes able to identify features and understand correlation. When the correlation of the coefficients S1 of the Lugre model with the position command S2, the speed command S3 and the position feedback S4 is understood to a certain reliable level, results of the learning that are repeatedly output from the reinforcement learning unit 833 become usable for performing selection (decision-making) of the action of determining what coefficients S1 of the Lugre model are to be set in response to the current state, namely, a speed command S3 and a position feedback S4. In this way, the reinforcement learning unit 833 generates a learning model that is capable of outputting the optimal solution of an action responsive to the current state.

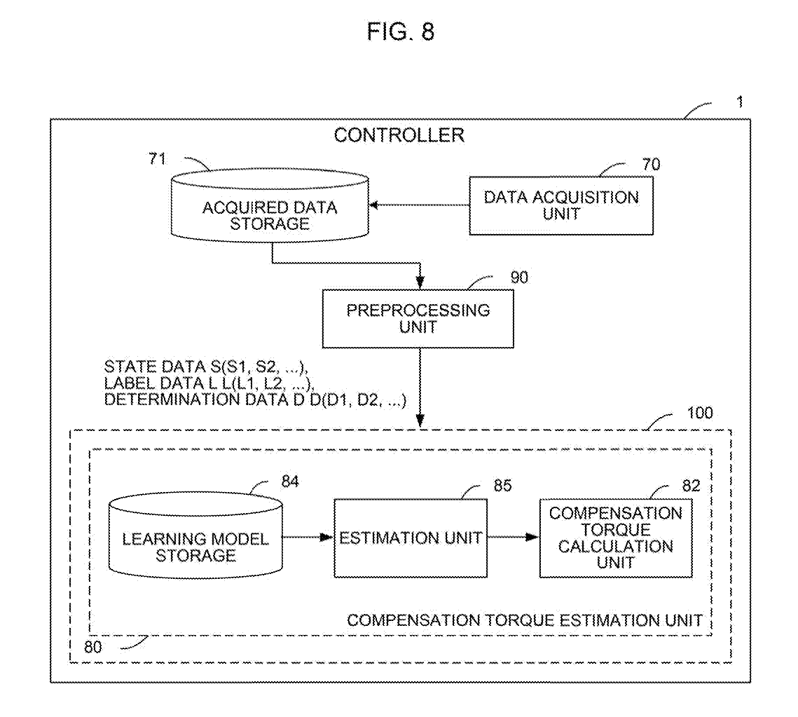

FIG. 8 is a schematic functional block diagram of a controller 1 and a machine learning device 100 according to the third embodiment. The controller 1 according to the present embodiment has a configuration required for the machine learning device 100 to perform estimation (an estimation mode). The functional blocks depicted in FIG. 8 are implemented by the CPU 11 of the controller 1 and the processor 101 of the machine learning device 100 illustrated in FIG. 3 executing their respective system programs and controlling operations of components of the controller 1 and the machine learning device 100.

As in the second embodiment, the controller 1 according to the present embodiment includes a data acquisition unit 70 and a compensation torque estimation unit 80 configured on the machine learning device 100. The compensation torque estimation unit 80 includes an estimation unit 85 and a compensation torque calculation unit 82. Further, an acquired data storage 71 for storing data acquired by the data acquisition unit 70 is provided on a nonvolatile memory 14 and a learning model storage 84 for storing a learning model built through machine learning by the learning unit 83 is provided on a nonvolatile memory 104 of the machine learning device 100.

The data acquisition unit 70 and a preprocessing unit 90 according to the present embodiment operate in a manner similar to that in the second embodiment. Data acquired by the data acquisition unit 70 is converted (by digitizing, sampling or otherwise) by the preprocessing unit 90 to a uniform format that is handled in the machine learning device 100, thereby generating state data S. The state data S generated by the preprocessing unit 90 is used by the machine learning device 100 for estimation.

Based on the state data S generated by the preprocessing unit 90, the estimation unit 85 estimates coefficients S1 of the Lugre model using a learning model stored in the learning model storage 84. The estimation unit 85 of the present embodiment inputs state data S input from the preprocessing unit 90 into the learning model (for which parameters have been determined) generated by the learning unit 83 and estimates and outputs coefficients S1 of the Lugre model.

The compensation torque calculation unit 82 uses results (a combination S1 of coefficients of the friction model) of estimation by the estimation unit 85 to calculate and output a compensation torque based on the friction model. The controller 1 adds the compensation torque output from the compensation torque calculation unit 82 to an electric current command.

According to the second and third embodiments, optimal coefficients that are suitable for various machines and use environments can be readily obtained because the machine learning device 100 generates a learning model representing correlation of coefficients S1 of the Lugre model with a position command S2, a speed command S3 and a position feedback S4 and estimates coefficients of the friction model using the learning model.

While embodiments of the present invention have been described, the present invention is not limited to the embodiments described above and can be implemented in various modes by making modifications as appropriate.

For example, in the above-described embodiments, while the controller 1 and the machine learning device 100 have been described as devices that have different CPUs (processors), the machine learning device 100 may be implemented by the CPU 11 of the controller 1 and a system program stored in the ROM 12.

Further, in a variation of the machine learning device 100, a learning unit 83 can use state variables S and determination data D acquired for each of a plurality of machines of the same type to learn coefficients of the Lugre model that are common to the machines. According to this configuration, the speed and reliability of learning can be improved because the amount of data sets that include states variables S and determination data D that can be acquired in a given period of time can be increased and a wider variety of data sets can be input. Further, the Lugre model can be further optimized for individual machines by using a learning model thus obtained as initial values and performing additional learning for each individual machine.

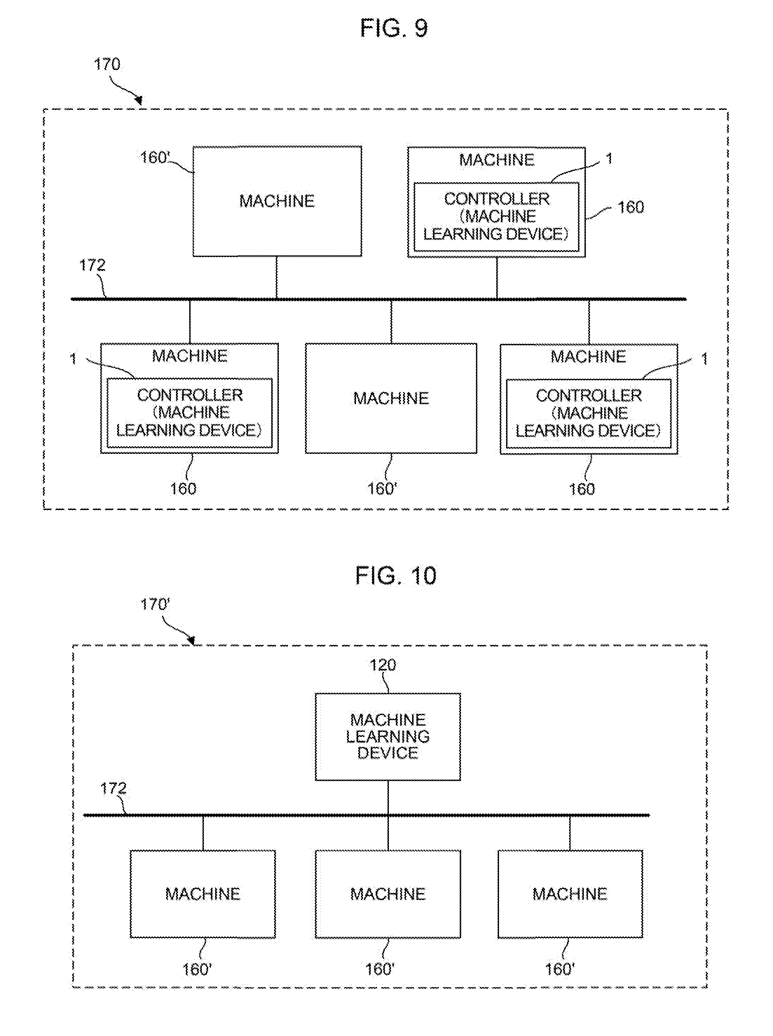

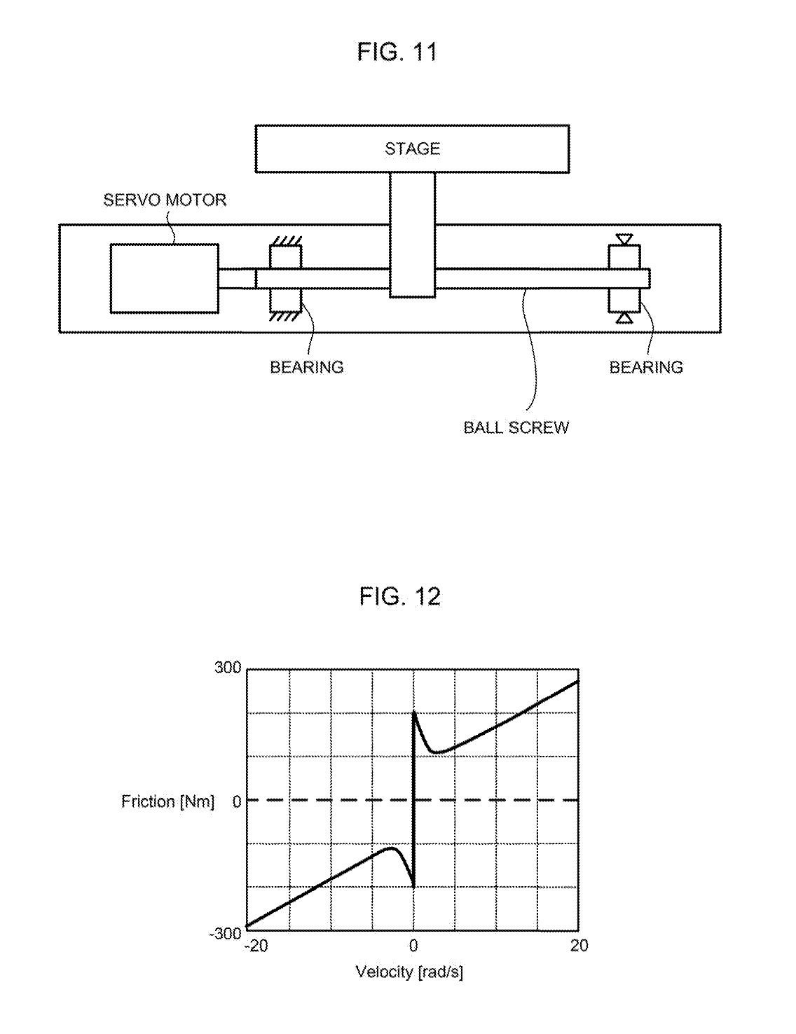

FIG. 9 illustrates a system 170 in which a plurality of machines are added to a controller 1. The system 170 includes a plurality of machines 160 and machines 160′. All of the machines 160 and the machines 160′ are interconnected through a wired or wireless network 172.

The machines 160 and the machines 160′ have mechanisms of the same type. Each of the machines 160 includes a controller 1 whereas the machines 160′ do not include a controller 1.

In the machines 160 that include the controller 1, an estimation unit 85 can estimate coefficients S1 of the Lugre model that correspond to a position command S2, a speed command S3 and a position feedback S4 using a learning model resulting from learning by a learning unit 83. Further, a configuration can be made in which the controller 1 of at least one machine 160 learns position control that is common to all of the machines 160 and the machines 160′ using state variables S and determination data D acquired for each of the other plurality of machines 160 and the machines 160′ and all of the machines 160 and the machines 160′ share results of the learning. The system 170 can improve the speed and reliability of learning of position control by taking inputs of a wider variety of data sets (including state variables S and determination data D).

FIG. 10 illustrates a system 170′ including a plurality of machines 160′. The system 170′ includes the plurality of machines 160′ that have the same machine configuration and a machine learning device 120 that is independent of a controller 1 (or a machine learning device 100 included in a controller 1). The plurality of machines 160′ and the machine learning device 120 (or the machine learning device 100) are interconnected through a wired or wireless network 172.

The machine learning device 120 (or the machine learning device 100) learns coefficients S1 of the Lugre model that are common to all of the machines 160′ on the basis of state variables S and determination data D acquired for each of the plurality of machines 160′. The machine learning device 120 (or the machine learning device 100) can estimate coefficients S1 of the Lugre model that correspond to a position command S2, a speed command S3 and a position feedback S4 using results of the learning.

This configuration allows a required number of machines 160′ to be connected to the machine learning device 120 (or the machine learning device 100) when needed regardless of the locations of the machines 160′ and timing.

While it is assumed in the embodiments described above that each of the controller 1 and the machine learning device 100 (or the machine learning device 120) is one information processing device that is locally installed, the present invention is not so limited. For example, the controller 1 and the machine learning device 100 (or the machine learning device 120) may be implemented in an information processing environment called cloud computing, fog computing, edge computing or the like.

Further, while methods of determining coefficients in the Lugre model, which is a typical friction model, have been presented in the embodiments described above, the present invention is not limited to the Lugre model and is applicable to determination of coefficients of various friction models, such as the Seven parameter model, the State variable model, the Karnopp model, the LuGre model, the Modified Dahl model, and the M2 model.

Further, while process machines, among others, have been presented as an example of machines in the embodiments described above, the present invention is not limited to process machines and is applicable to various machines (for example, robots such as medical robots, rescue robots, and construction robots) that have a driving mechanism, typically a positioning mechanism, in which friction becomes a problem.

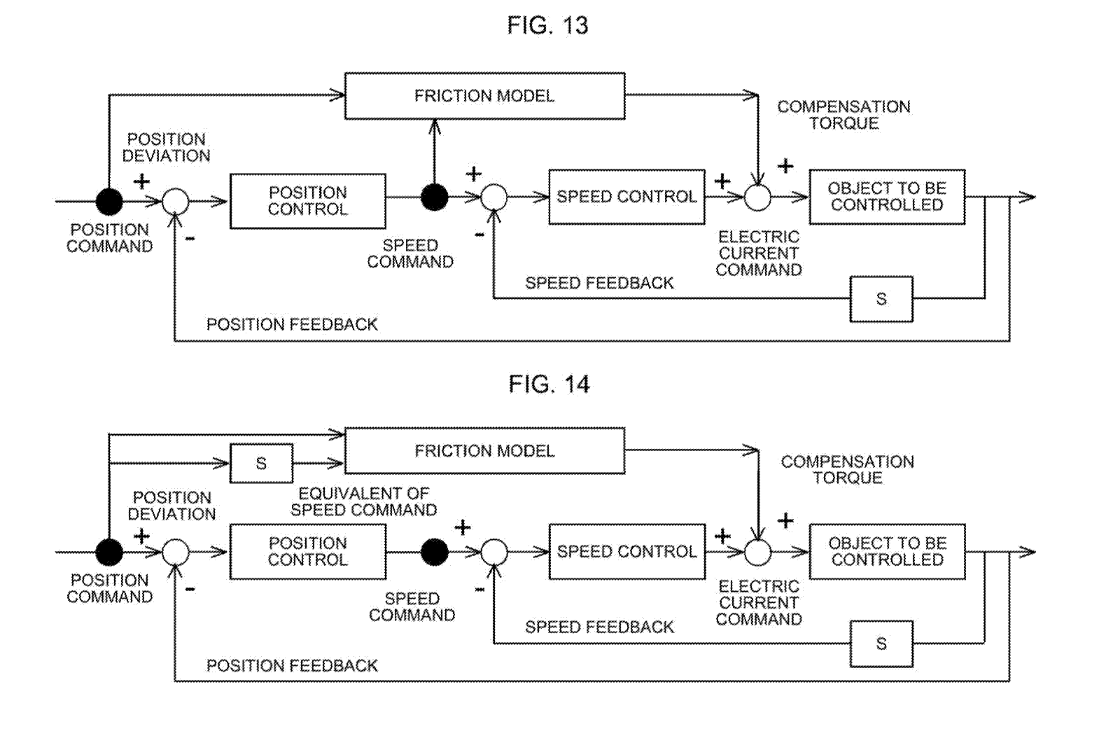

Moreover, while the embodiments described above obtain coefficients of the friction model based on the control system illustrated in FIG. 13, the present invention is not limited to this and is also applicable to various control systems that are variations of the control system. For example, a control system may be used in which, instead of a speed command, s=an equivalent of a speed command that is a derivation of a position command is input into the friction model as illustrated in FIG. 14. In this case, the state observation unit 831 of the machine learning device 100 observes the equivalent s of the speed command instead of the speed command. This configuration has an advantage that calculation of a compensation torque can be completed on the controller 1 side alone because the compensation torque can be calculated using only a position command.

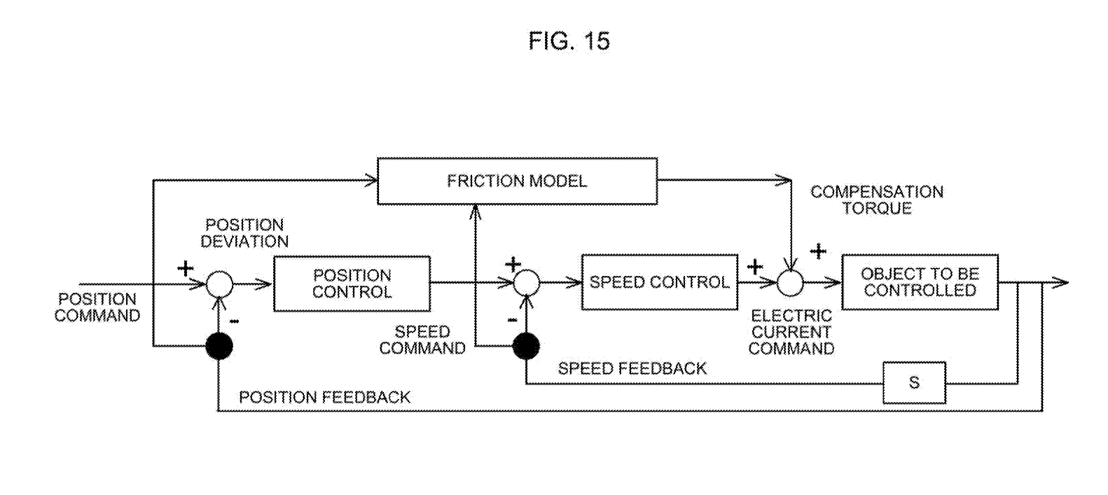

Alternatively, a control system may be used in which, instead of a position command and a speed command, a position feedback and a speed feedback are input in the friction model as illustrated in FIG. 15. In this case, the state observation unit 831 of the machine learning device 100 observes the position feedback instead of the position command, and the speed feedback instead of the speed command. This configuration can be readily implemented on the axis control circuit 30 side. Fast processing can be performed and actual friction can be more easily estimated because feedbacks are used.

While embodiments of the present invention have been described above, the present invention is not limited to the example embodiments described above and can be implemented in other modes by making modifications as appropriate.

1. A controller performing, for one or more axes of a machine, position control that takes friction into consideration, the controller comprising:
a data acquisition unit acquiring at least a position command and a position feedback; and
a compensation torque estimation unit estimating coefficients of a friction model used when the position control is performed, on the basis of a position deviation that is a difference between the position command and the position feedback.

2. The controller according to claim 1, wherein the compensation torque estimation unit comprises an optimization unit estimating coefficients of the friction model by solving an optimization problem that minimizes the position deviation.

3. The controller according to claim 1, wherein the compensation torque estimation unit comprises a learning unit that performs machine learning using state variables including coefficients of the friction model, a position command and a position feedback, and a speed command or a speed feedback, and generates a learning model.

4. The controller according to claim 3, wherein the learning unit performs reinforcement learning on the basis of determination data representing a result of the position control.

5. The controller according to claim 1, wherein the compensation torque estimation unit comprises:
a learning model storage for storing a learning model trained by machine learning using coefficients of the friction model, a position command and a position feedback, and a speed command or a speed feedback; and
an estimation unit estimating coefficients of the friction model using the learning model on the basis of a position command and a position feedback, and a speed command or a speed feedback.

6. The controller according to claim 1, wherein the data acquisition unit acquires data from a plurality of the machines.

7. The controller according to claim 1, wherein the friction model is any of Lugre model, Seven parameter model, State variable model, Karnopp model, LuGre model, Modified Dahl model, and M2 model.

8. A control method for performing, for one or more axes of a machine, position control that takes friction into consideration, the control method comprising:
a data acquisition step of acquiring at least a position command and a position feedback; and
a compensation torque estimation step of estimating coefficients of a friction model used when the position control is performed, on the basis of a position deviation that is a difference between the position command and the position feedback.
